(19) United States
(12) Patent Application Publication
(10) Pub. No.: US 2011/0236870 A1
(43) Pub. Date: Sep. 29, 2011

(54) SYSTEM AND METHOD FOR LEARNING

(75) Inventors: Kris Chinosornvatana, Chicago, IL (US); Vincent K. Leung, Chicago, IL (US)

(73) Assignee: MENTORMOB, INC., Chicago, IL (US)

(21) Appl. No.: 13/038,975

(22) Filed: Mar. 2, 2011

Related U.S. Application Data
(60) Provisional application No. 61/318,278, filed on Mar. 26, 2010.

(51) Int. Cl. G09B 7/00

(52) U.S. Cl. 434/322

(57) ABSTRACT

A collaborative learning system and method, which allows a user to create and organize at least one learning path and to find consolidated content on particular subjects is provided. Also provided is a computer-readable storage medium containing a program, which when executed by a computer, performs an operation. The method includes creating one or more study items and storing electronically the one or more study items. The method also includes adding the one or more study items to a learning path, wherein the learning path is electronically stored, and wherein each of the one or more study items has an associated designation. The method further includes arranging the one or more study items within the learning path in a logical order, wherein the learning path incrementally provides information regarding a particular topic as the learning path is traversed.

### CROSS REFERENCE TO RELATED APPLICATIONS

This application claims the benefit of U.S. Provisional Patent Application No. 61/318,278, filed under the same inventors on Mar. 26, 2010; the application is incorporated by reference herein, in its entirety, for all purposes.

### BACKGROUND

1. Field of The Invention

The present disclosure relates generally to computer data and information systems accessed over computer networks. More particularly, the present disclosure relates to a computer-based system for learning various activities, hobbies, interests or any subject matter that can be learned and connecting users of the system to learn from each another over the Internet.

2. Description of Related Art

In a traditional learning environment, an individual may be taught, or may learn multiple subjects concurrently. A person may organize these subjects into one or many physical or virtual notebooks which act as learning aids and/or repositories of knowledge, able to be accessed at a later time. Traditional learning environments expect a person to self-organize their learning process of multiple subjects according to his/her own style or need, typically without much guidance as to how to organize each subject's key tenets, rules, principles or facts. It is desirable to offer a system and method for a person to learn or be taught multiple subjects concurrently by allowing a person to become immersed in each subject and aggregating multiple teachers, students, study content and practice content in one system where each subject's key tenets, rules, principles or facts can be presented in one or many physical or virtual notebooks in an order suitable for learning. Such information could be manipulated so that the order may be changed by each person using the system to fit his/her particular style of learning or teaching.

### SUMMARY OF EMBODIMENTS OF THE INVENTION

In one embodiment of the present invention, a method is provided. The method includes creating one or more study items and storing electronically the one or more study items. The method also includes adding the one or more study items to a learning path, wherein the learning path is electronically stored, and wherein each of the one or more study items has an associated designation. The method further includes arranging the one or more study items within the learning path in a logical order, wherein the learning path incrementally provides information regarding a particular topic as the learning path is traversed.

In another embodiment of the present invention, a system is provided. The system includes a processor and a memory containing a program, which when executed by the processor, is configured to perform an operation. The operation includes creating one or more study items and storing electronically the one or more study items. The operation also includes adding the one or more study items to a learning path, wherein the learning path is electronically stored, and wherein each of the one or more study items has an associated designation. The operation further includes arranging the one or more study items within the learning path in a logical order, wherein the learning path incrementally provides information regarding a particular topic as the learning path is traversed.

In yet another embodiment of the present invention, a computer-readable storage medium containing a program, which when executed by the computer performs an operation. The operation includes creating one or more study items and storing electronically the one or more study items. The operation also includes adding the one or more study items to a learning path, wherein the learning path is electronically stored, and wherein each of the one or more study items has an associated designation. The operation further includes arranging the one or more study items within the learning path in a logical order, wherein the learning path incrementally provides information regarding a particular topic as the learning path is traversed.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 illustrates a block diagram showing an exemplary computing environment, in accordance with an embodiment of the present invention;

FIG. 2 illustrates a diagram of various components of a collaborative learning system, in accordance with an embodiment of the present invention;

FIG. 3 illustrates an exemplary HTML page showing a user profile containing a learning path, in accordance to an embodiment of the present invention;

FIG. 4A illustrates a learning path including a button to add or create a study item, in accordance to an embodiment of the present invention;

FIG. 4B illustrates a dialog box containing various fields that are populated to add or create a study item, in accordance to an embodiment of the present invention;

FIG. 4C illustrates a learning path after a new study item is added, in accordance to an embodiment of the present invention;

FIG. 5 illustrates an example HTML page illustrating the modification of a learning path, in accordance to an embodiment of the present invention;

FIG. 6 illustrates a method for adding study items to a learning path, in accordance to an embodiment of the invention;

FIG. 7 illustrates a method for using and rearranging a learning path, in accordance to an embodiment of the present invention;

FIG. 8 illustrates a diagram representing a snapshot of a collaborative learning path with study items to which more than one user has contributed, in accordance to an embodiment of the present invention;

FIG. 9 illustrates a method for traversing a learning path, in accordance to an embodiment of the present invention;

FIG. 10 illustrates an example HTTP page including a navigational pane embedded over target content, in accordance to an embodiment of the present invention;

FIG. 11 illustrates navigation pane in its collapsed form, in accordance to an embodiment of the present invention;

FIG. 12 illustrates method for traversing a learning path using a navigation pane, in accordance to an embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but, on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Embodiments of the present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the presented embodiments. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

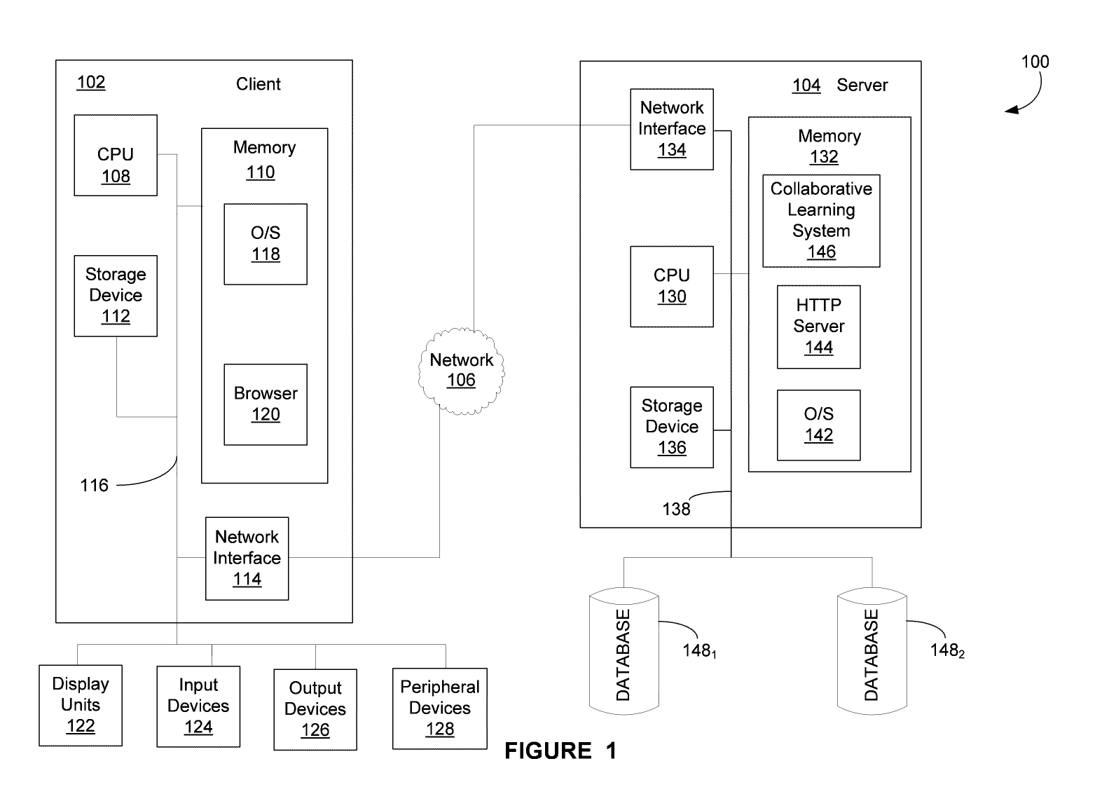

One embodiment of the invention is implemented as a program product for use with a computer system such as, for example, the computing environment 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that may be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature. In this regard, references to particular definitional languages, such as HTML and XML, are merely illustrative. It is broadly contemplated that the embodiments herein are applicable regardless of the particular schema or language used to defined network resource content.

Embodiments of the disclosure are directed to a collaborative learning system which allows a user to create and organize at least one learning path and to find consolidated content on particular subjects. In addition, the collaborative learning system may match users based on a set of criteria gathered from a user's discrete data, which may include inputted data and browsing history. A learning path may be a visually displayed list that contains at least one or more pieces of content, or study items. In one embodiment, the learning path containing the one or more pieces of content may be for learning a given subject, interest, activity, hobby or anything which can be categorized (i.e., scuba diving, guitar playing, fourth grade history, freshman year chemistry, the Boy Scouts of America merit badge system, etc.). These subjects, interests, activities, hobbies, etc., are organized into networks and will be referred to as “Groups” herein. In another embodiment, the learning path containing the one or more pieces of content may be for performing a particular task in a certain order.

The collaborative learning system may provide a plurality of Groups for multiple users to join. For example, a user may search for and/or join a Group organized around a subject which he is interested in learning, improving upon, or helping others learn. A user may join and/or belong to zero or more Groups. A user who does not belong to at least one Group may be considered to have provisional access to the collaborative learning tool system and may have reduced privileges as a user within the website. Conversely, a user who belongs to one or more Groups may be considered to be a registered user and have extra privileges. The collaborative learning tool system may be displayed to a user via a web page or webpages, which contain navigation to allow for categorization of the various Groups. Each Group may be formatted in a standard framework and/or layout. The framework for any given Group may consist of any number of sections, examples of which are illustrated below.

In one embodiment, the collaborative learning system may incorporate one or more algorithms used to match users with one another based on a variety of criteria such as the number and type of common Groups, experience level, location of users, age, gender, learning/teaching methods, etc. Various statistics of the collaborative learning tool system may be aggregated and available within the learning tool system and displayable to users, such as the highest rated mentors, the highest rated mentees, the users with most friends within a Group, users currently online and accessing the website, nearby users based on location, etc. Once a user finds another user with which to connect, a connection may be made via electronic communication, which may result in an off-line, real-world meeting for more personal learning or activities to take place.

In one embodiment, the collaborative learning system 146 may target non-professional or professional users as mentors (teachers) to help less experienced users learn a particular subject matter. The driving force behind the collaborative learning system 146 is that as long as one user knows more than another user in a particular subject matter, then knowledge may be passed on. This differs from traditional teaching where a student receives education in exchange for a fee. In another embodiment, the collaborative learning system 146 may be used for corporate training. That is, a corporation may utilize the collaborative learning system 146 to train their employees in regard to a variety of subjects and/or topics.

It is contemplated that different embodiments described herein may be implemented together in various combinations, as would be apparent to one of skill in the art having benefit of this disclosure. That is, embodiments depicted herein are not mutually exclusive of each other and may be practiced alone, or in any combination, in accordance with the descriptions herein.

Turning now to FIG. 1, a block diagram illustrating an exemplary computing environment 100, in accordance with one embodiment, is shown. In general, the computing environment 100 includes a client (e.g., a user's computer) computer 102, and a server computer 104. The client computer 102 and the server computer 104 may be components of the same computer system or may be connected via a network 106, such as the Internet. In various embodiments the client computer 102 may be a personal computer, a laptop computer, a handheld computer, a netbook computer, a mobile device, a telephone, a personal data assistant (PDA), a server, a mainframe, a work terminal, or the like. It is also noted that in various embodiments, any number of client computers 102 may be communicatively coupled and/or connected to each other and the server computer 104 through a network infrastructure 210. It is further noted that in various embodiments, any number of client computers 102 may be communicatively coupled to and/or connected to each other and one or more server computers 104 via a distributed network environment.

As shown, the client computer 102 may include a central processing unit (CPU) 108 connected to a memory 110, a storage device 112, and a network interface 114 via a bus 116. The CPU 108 is included to be representative of a single CPU, multiple CPUs, a single CPU having multiple processing cores, and the like. The storage device 112 may store application programs and data for use by the client computer 102. Examples of the storage device 112 include one or more hard-disk drives, flash memory devices, optical media and the like. The client computer 102 may be connected to the data communications network 106 (e.g., a local area network, which itself may be connected to other networks such as the internet) using the network interface 114. The memory 110 can be one or a combination of memory devices, including random access memory, nonvolatile or backup memory (e.g., programmable or flash memories, read-only memories, etc.). Illustratively, the memory 110 of the client computer 102 may store an operating system 118 that may be used to manage hardware and software executing on the client computer 102. As shown, memory 110 may also include a browser program 120 which, when executed by a processor (e.g., CPU 108), may provide support for navigating between various servers and locating network addresses at one or more of servers (e.g., server computer 104).

The client computer 102 may be connected to one or more display units 122, input devices 124, output devices 126 and peripheral devices 128. The display units 122 may be internal or external monitors, television screens, handheld device displays, and the like. The input devices 124 may be any one of a keyboard, mouse, track-ball, stylus, mouse pad, mouse button, joystick, scanner or the like. The output devices 126 may be any one of a monitor, printer, plotter, copier or other output device. The peripheral devices 128 may be any other device which can be coupled to a computer: a CD/DVD drive capable of reading and/or writing to physical digital media, a USB device, Zip Drive, external floppy drive, external hard drive, phone and/or broadband modem, router/gateway, access point and/or the like.

Similar to the client computer 102, the server computer 104 may include a CPU 130, a memory 132, a network interface device 134, and a storage device 136, coupled via a bus 138. The memory 132 may be a random access memory sufficiently large to hold the necessary programming and data structures that are located on the server computer 104. As shown, the memory 132 stores an operating system 140 used to manage server hardware and software executing on the server computer 102. Illustratively, the memory 132 may also include a hypertext transfer protocol (http) server 144 configured to service requests from the client computer 102. For example, the http server 144 may respond to requests for access to electronic resources (e.g., HTML documents, network information, and/or the like) that may reside on the server computer 104. However, one of ordinary skill in the art will recognize that the http server 144 is merely illustrative and embodiments of the invention may be adapted to support both known and unknown protocols. The programming and data structures of the http server 144 may be accessed and executed by the CPU 130 as needed during operation. The server computer 104 may connect to the network 106 using the network interface device 134 (e.g., an analog modem, a wired network card, or a wireless network device, and/or the like).

In one embodiment, users may interact with the server computer 104 using a graphical user interface (GUI). In a particular embodiment, GUI content may comprise HTML documents (i.e., web pages) rendered on the display unit 122 coupled with the client computer 102 using the browser 120. In one embodiment, the web pages may include pages that may allow a user to design, manipulate, execute and monitor a collaborative learning tool system, which may allow a user to create and organize at least one learning path and to find consolidated content on particular subjects.

Accordingly, the memory 132 may further include a collaborative learning system 146. The collaborative learning system 146 may be a software application configured to provide the ability (e.g., via a web page rendered on the display unit 122) to view and create user profiles, view and create learning paths associated with each user profile, share learning paths among different users, and match users based on a set of criteria gathered from a user's discrete data.

Information associated with each user profile may be stored in one or more databases 148₁, 148₂, coupled to the server computer 104. Study items and/or learning paths (which may include the information associated therewith) may also be stored on the databases 148₁, 148₂. The one or more databases 148₁, 148₂ may include a relational database 148₁ that is queried using an SQL query, or an XML database 148₂ queried using an XML query. The embodiments herein, however, are not limited to any particular physical database storage mechanism and may readily be extended to operate on other such mechanisms, whether currently known or unknown. While the databases 148₁, 148₂ are illustrated as being external to the server system, it is noted that the databases 148₁, 148₂ may exist on a local storage device (e.g., storage device 136) of the server computer 104, or may be accessed over the network 106.

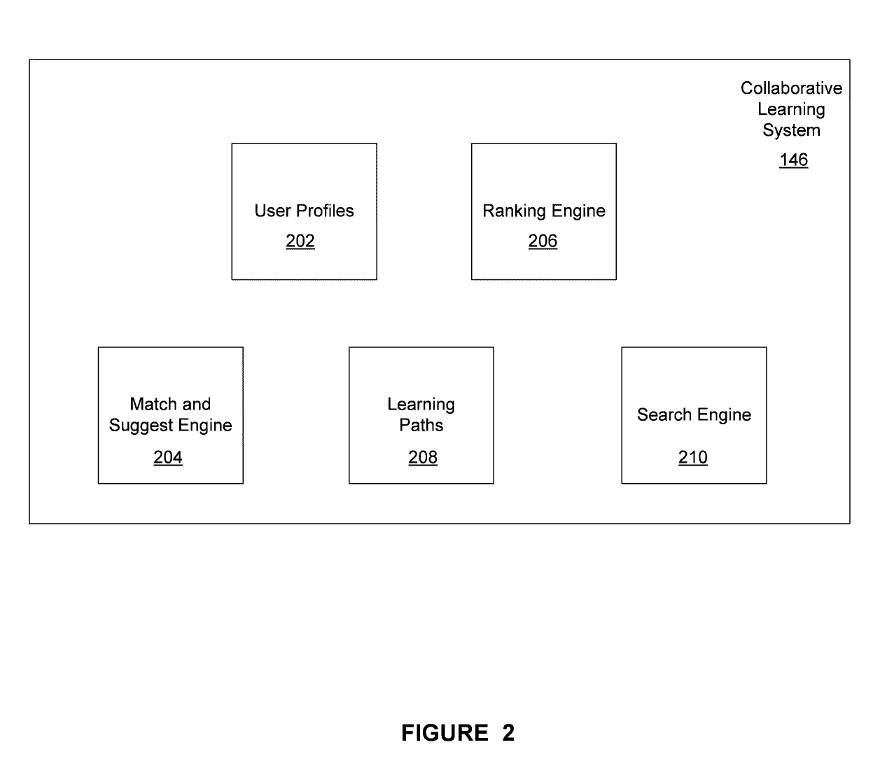

Turning now to FIG. 2, a diagram illustrating various components of the collaborative learning system 146, in accordance with one or more embodiments, is illustrated. As shown, the collaborative learning system 146 may include user profiles 202, a match and suggest engine 204, a ranking engine 206, learning paths 208, and/or a search engine 210. While the user profiles 202 and learning paths 208 are shown as being components as the collaborative learning system 146, it is noted that the user profiles 202, the learning paths 208 and/or the data associated therewith may also be stored on the databases 148₁, 148₂.

Each user may have a user profile 202 and/or identity to create and/or edit. Each user profile 202 may be associated with any number of discrete pieces of content including, but not limited to (1) a user's identity, such as a name and a profile picture; (2) a user's learning path 208 for a one or more subjects which can display past, present and future study items; (3) a method to contact a user electronically, such as by electronic mail; (4) a score or rating based on how helpful a user is in a particular learning path; (5) experience level for a Group; (6) a listing and count of connections within a Group; (7) a listing and count of Groups in which a user is a mentor/teacher; (8) a listing and/or count of Groups in which a user is a mentee/student; (9) a mentor/student description of how a user may help another user to learn a particular subject matter, which may include being an activity partner, teaching specific skills, introducing a user to other users, providing pre-recorded videos, audio, charts, diagrams or illustrations to demonstrate skill, technique and/or any other behavior; (10) a mentee/student description of how and/or what a user wants to learn of a particular subject matter; (11) study items recommended to others; (12) reviews by other users of a particular user's mentoring/teaching ability; and/or (13) suggested content for each Group joined by the user. The suggested content includes, but is not limited to articles, videos, events, and forums, or anything else related to a Group's subject matter. The suggested content is meant to keep a user immersed in a particular Group and may also act as practice exercises for the user. In addition, each article, video, event or forum may be added to a learning path 208.

The match and suggest engine 204 may be adapted to match users based on a set of criteria gathered from a user's discrete data. Using the discrete data, the match and suggest engine 204 may determine suitable matches between users. For example, in one embodiment, the match and suggest engine 204 may match mentors (teachers) to mentees (students), and/or vice versa. The match and suggest engine 204 may categorize every user to a specific learning and/or teaching style, using one or more predetermined and accepted learning and/or teaching styles, as are known by those skilled in the art. Categorization may involve algorithmic deduction based on user clicks, surveys posed to users to capture answers to specific questions, determination through analyzing a user's comments and/or reviews submitted to the collaborative learning system 146, and/or determination through analyzing a user's uploaded content, links, and/or text submitted to the collaborative learning system 146.

The ranking engine 206 may determine a unique Group importance indicator for each user. The importance indictor may indicate the percentage of interest or activity for each Group a user has joined. Each user may have a different Group importance indicator for any given Group. The importance indicator may be dynamic and change percentages based on the addition or subtraction of a Group or Groups from a user's profile and on the time or level of engagement a user has with a particular Group or Groups. The percentage of interest or activity may be calculated using a weighted system and may be based on a number of criteria including (1) the number of groups of which a user has joined; (2) the number of friends or connections a user has within a particular group or groups he has joined; and (3) the amount of engagement a user has with a Group or Group he has joined. Such engagement may include a user submitting articles, videos, items, comments, study items, events, mentor reviews or mentee reviews, the number of mentor/mentee connections, the number of attended events, the number of completed study items, and or the like.

The unique Group importance indicator for each user may be used for a variety of purposes: (1) to match like-minded users (e.g., via the matching engine 204) to one another using a similarity percentage by comparing one user's Group importance indicator against one or multiple other user's Group importance indicator, or by using other factors including age, location, gender, current user connections and time belonging to a particular Group, or by using vector space modeling; (2) to match advertisers with potential customers (e.g., via the matching engine 204); (3) to provide a visual representation of “who a user is” by means of a bar graph, pie chart, histogram or other known visual percentage representation model; and (4) to provide a navigation tool within the collaborative learning system 146 provided that a visual or textual representation of a user's Group importance indicator is hyperlinked to the particular Group or Groups represented within.

Once the match and suggest engine 204 determines a match (e.g. between mentors and mentee, between advertisers and customers, or between users in general) the match and suggest engine 204 may suggest and/or display the match to the user via the user's profile 202. For example, the match and suggest engine 204 may suggest a user to be friends with other users, to enter into a mentor/mentee relationship with other users, and/or suggest a product to purchase. Suggesting a user to another user may involve analyzing a user's behavior metrics through his interaction with the website interface and the collaborative learning system 146. Behavior metrics tracked by the system may algorithmically deduce which user profiles should be shown to each particular user to connect with. Such behavior metrics may include, but are not limited to, the particular Groups a user is a member of and the similarity of two users' content viewed, uploaded and/or linked to. A similarity rating may be utilized using a vector space model, as would be known by those skilled in the art having the benefit of this disclosure. Each user may be represented as a vector within the collaborative learning system 146 and each criterion used to determined “like-mindedness” would be a term plotted in a vector space. To calculate a similarity rating between two users, one may take the cosine of the angle between two users' vectors. As will be discussed below, the match and suggest engine 204, may also suggest study items that can be added to a user's learning path 208.

In one embodiment, when matching advertisers with customers, the collaborative learning system 146 may display links to and/or descriptions of products related to a Group that are determined to be match. Each product may be rated/reviewed by users within a Group and may also link to retailers so a user may purchase these products directly via the collaborative learning system 146 website. A separate system may be used to determine the best price among the retailers and possibly suggest similar products. Additional information may include a count of the number of users who use a particular product. The number of members of a Group may be leveraged in order to get discounts for bulk purchases from retailers.

Referring still to FIG. 2, the collaborative learning system 146 may also include a plurality of learning paths 208. As previously stated, a learning path 206 is a list (which may be displayed to a user) that contains at least one or more pieces of content for learning a given subject, interest, activity, hobby or anything which can be categorized. Each of the learning paths 208, and its associated study items, may also be stored on the databases 148₁, 148₂.

The search engine 210 may be used by the user to search for learning paths 208 and/or study items. The search may be based by topic, rating and/or user. Similarly, the search engine 210 may also be used to search for mentors and/or other users.

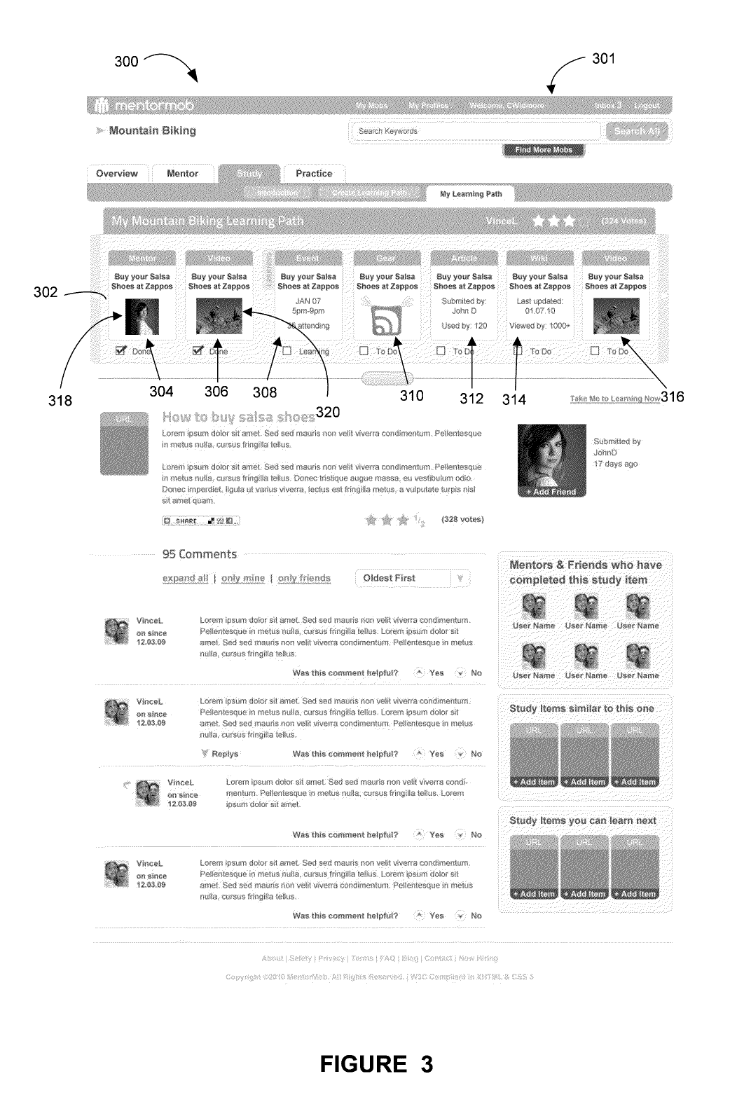

Turning now to FIG. 3, an example HTML page 300 illustrating a user profile 301 containing a learning path 302, in accordance to with one embodiment, is shown. The learning path 302 may include a plurality of study items 304, 306, 308, 310, 312, 314, 316, which may represent a particular piece of content. In one embodiment, each study item 304, 306, 308, 310, 312, 314, 316 within a learning path 302 may be followed by another in a logical order. For example, the learning path 302 may start with a first study item 304 (first, sequentially, in the learning path 302) and may end with a last study item 316 (last sequentially in the learning path 302). Within a learning path 302, a study item or a plurality of adjacent study items may be tagged and indicated as “learning” (e.g. study item 308) or “learning now”. Study items designated as such may indicate that a user is currently learning those study items. Any study items (e.g. study items 304, 306) in a learning path 302 that are placed before a “learning now” study item 308 are all considered to be “done” or “completed”. “Done” or “completed” study items 304 306 represent the learning history of a user. Any study items (e.g., study items 310, 312, 314, 316) starting after the last “learning now” study item 308 may all be considered to be “not completed” and may represent future study items to be learned and completed. The study items 304, 306, 308, 310, 312, 314, 316 may be arranged such that each study item incrementally builds on the knowledge gained from previously learned (or “completed”) study items in the learning path 302.

Each study item 304, 306, 308, 310, 312, 314, 316 may contain various pieces of discrete data, including, but not limited to (1) a link to a piece of content (e.g., articles, videos, events, wiki articles, external websites, products, short notes, documents (e.g., text documents, Microsoft Word documents, PDF's, Google Docs, and the like), spreadsheets (e.g., Microsoft Excel spreadsheets, Google Docs spreadsheets, and the like, images, learning games (e.g. Flash-based and/or Java-based games, and the like), another learning path, or any other piece of information or object to be used to learn a particular subject); (2) a rating value based on users who have used, viewed or otherwise interacted with a study item 304, 306, 308, 310, 312, 314, 316 and/or evaluated its value; (3) a listing and count of how many users have rated a study item 304, 306, 308, 310, 312, 314, 316; (4) reviews by users of a study item 304, 306, 308, 310, 312, 314, 316; (5) a listing and count of reviews of a particular study item 304, 306, 308, 310, 312, 314, 316; (6) a listing and count of how many users currently have a study item 304, 306, 308, 310, 312, 314, 316 in a learning path; (7) a listing and count of how many users have a particular study item 304, 306, 308, 310, 312, 314, 316 marked as currently learning; (7) identification of the user who submitted a particular study item 304, 306, 308, 310, 312, 314, 316; (8) a unique identification number and/or alpha-numeric string to uniquely identify a study item 304, 306, 308, 310, 312, 314, 316; (9) users who have recommended a particular study item 304, 306, 308, 310, 312, 314, 316 to other users; (10) a difficulty level (e.g., beginner, intermediate, advanced); and/or (11) keywords or tags to help in system-wide taxonomy, searching, and recommending similar study items 304, 306, 308, 310, 312, 314, 316. In one embodiment, a study item may be designated as a “decision” study item, which may provide a user an option to select between one of several study items as the next study item in the learning path 302.

Study items 304, 306, 308, 310, 312, 314, 316 may also be categorized into a discrete number of types, so as to allow a user to quickly identify a study item within a learning path 302 by type. Each of the pieces of discrete data stated above may be stored as metadata associated with a particular study item. In addition, each of the pieces of discrete data may be displayed to the user. For example, as shown in FIG. 3, study item 304 contains a link 318 to a mentor's profile page and study item 306 contains a link 320 to a video.

A user may create his personal learning path(s) 302 for each Group of which he/she is a member by creating and adding study items 304, 306, 308, 310, 312, 314, 316 and/or adding, removing, and/or rearranging various study items 304, 306, 308, 310, 312, 314, 316 contained within an already existing learning path. This dynamism of any learning path 301 may allow users to react to new information and stay organized with the same. A user may also create a personal learning path(s) that stands alone, outside of any Group. As the learning path 302 progresses from beginning to end, the skills detailed, or information accrued, within each study item will help to increase a user's experience or expertise in that Group.

In addition, as a user progresses through the learning path 302, the user may be assigned a skill level. In one embodiment, the skill level of a user may be determined by the skill level assigned to the “learning” study item 308. For example, if a study item has a skill level of “Beginner” (e.g., study item 304) and that study item is currently being “learned”, then the user may be assigned a skill level of “Beginner”. Likewise, if a study item has a skill level of “Intermediate” (e.g., study item 308) and that study item is currently being “learned”, then the user may be assigned a skill level of “Intermediate”. In another embodiment, the skill level of a user may be determined by where the user is within his learning path 302. For example, suppose that a learning path 302 contains 30 study items. In this case, if the user is learning one of the first ten study items, the user may be assigned a skill level of “Beginner.” If the user is learning one of the middle ten study items, then the user may be assigned a skill level of “Intermediate.” Finally, if the user is learning one of the last ten study items, the user may be assigned a skill level of “Advanced.”

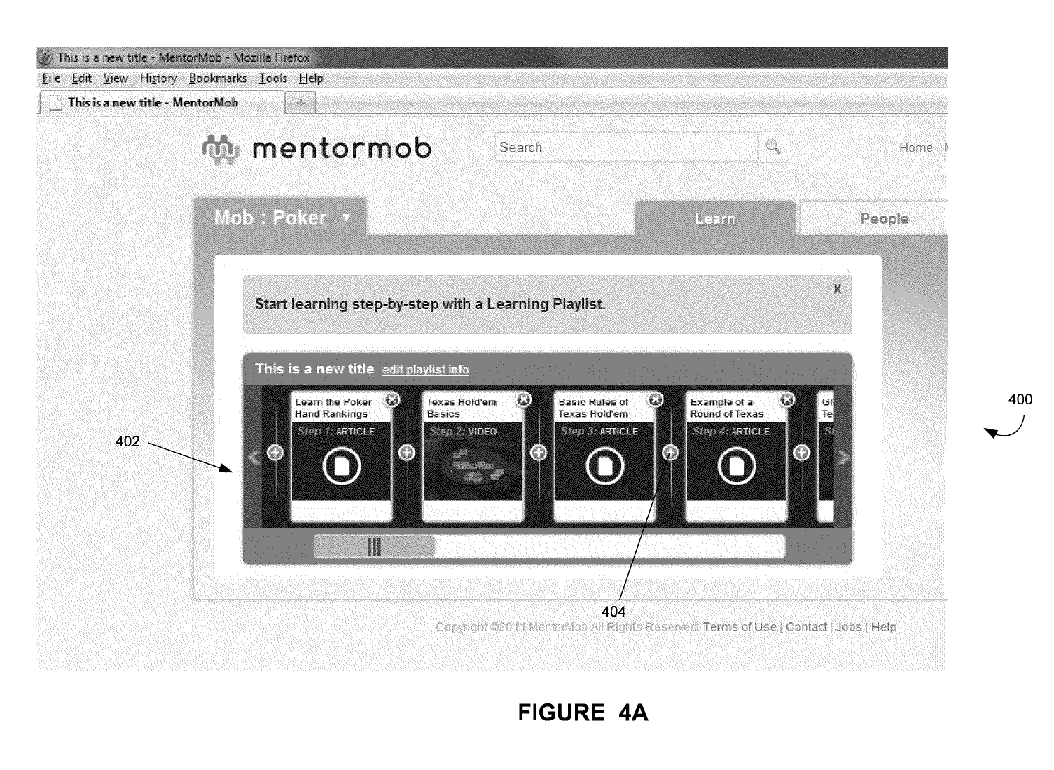

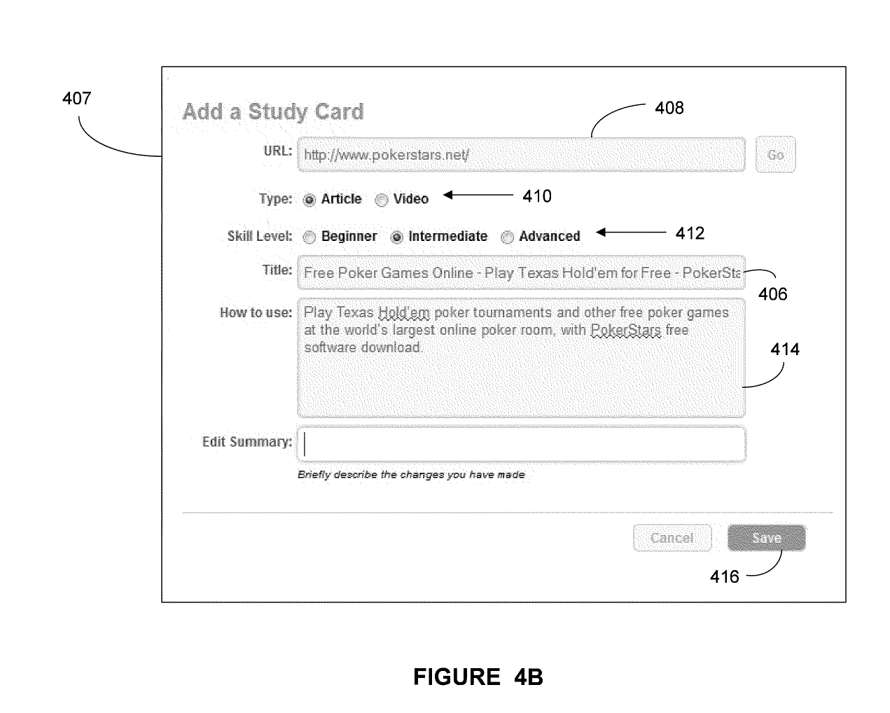

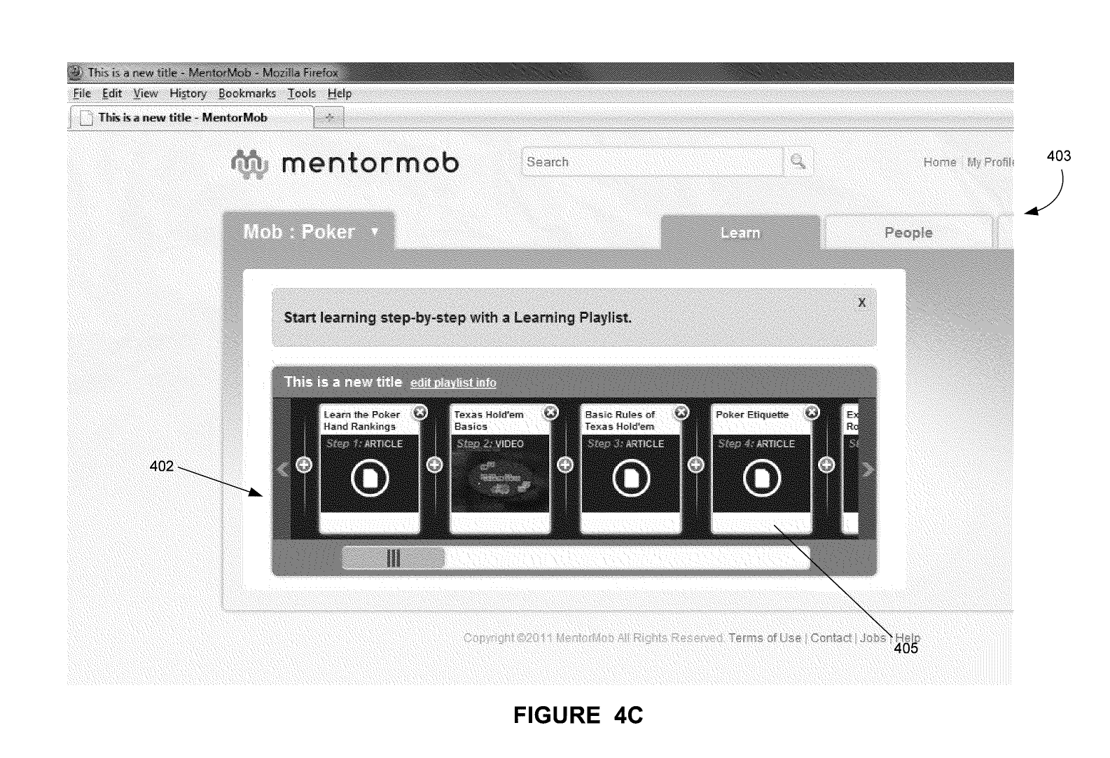

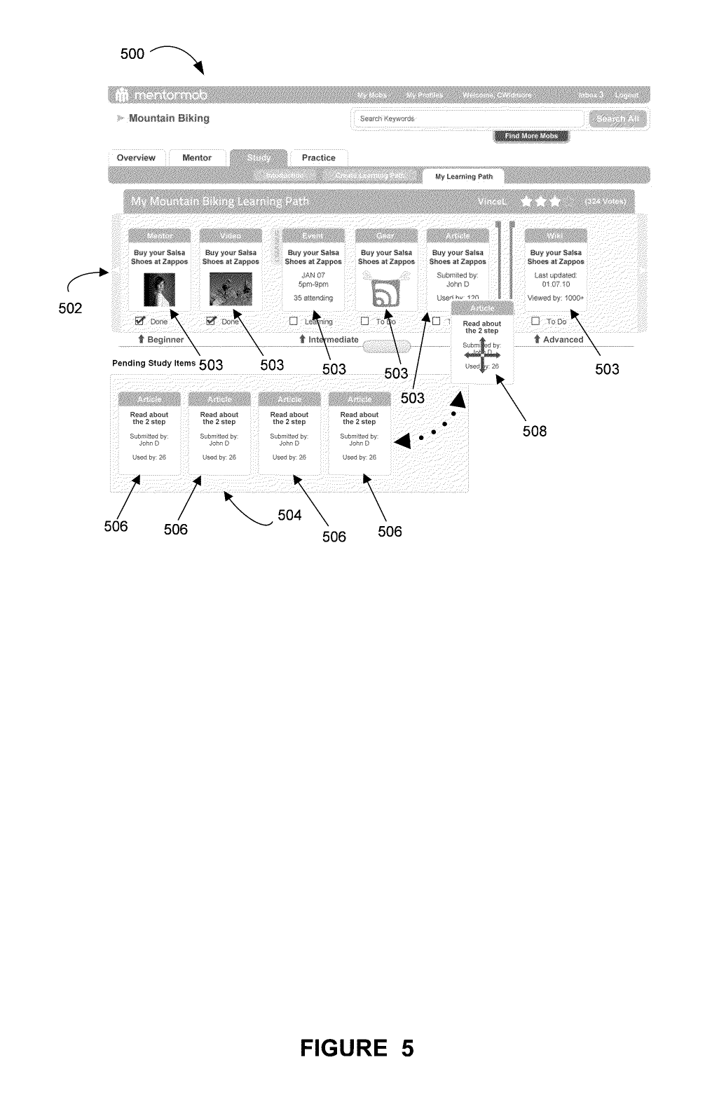

Turning now to FIGS. 4A-4C, FIG. 4A-4C illustrate exemplary HTML pages demonstrating how to create a new study item, in accordance to embodiments of the present invention. FIG. 4A illustrates a sample HTML page 400 displaying a learning path 402 including a button 404 to add or create a study item. FIG. 4B illustrates a dialog box 407 containing various fields that are populated to add or create the study item. FIG. 4C shows a sample HTML page 403 displaying the learning path 402 after the new study item 405 is added. As shown in FIG. 4A, a user may click on a button and/or link 404 that may direct the user via a dialog box 407, as shown in FIG. 4B, to name the study item (e.g., via the title field 406) and assign a piece of content to the study item 405. In one embodiment, a user may assign a web address to the study item 405 by typing a Uniform Resource Locator (URL) in a URL field 408. The user may also designate the type for the study item (e.g., via the “Type” radial buttons 410), assign a skill level to the study item (e.g. via the “Skill Level” radial buttons 412, and provide a brief description of the study item (e.g., via the “How to Use” field 414). The URL may be linked to a web page that contains profiles of users, articles, videos, audio, pictures, wikis, events, forums, products, reviews, etc. In another embodiment, the user may assign another learning path to the study item by typing the name of the learning path or a unique identification number associated with the learning path in an Identification field (not shown). Likewise, the user may also designate the type of the study item as a “learning path” (e.g., via the “Type” radial buttons). Once the user is finished creating the study item 405, the user may save the study item (e.g., via the “Save” button 416). In one embodiment, once the study item 405 has been saved, the newly-created study item (405, as shown in FIG. 4C) may be inserted into the appropriate position of the learning path 402. As shown, Step 4 of the learning path 402 is now the newly-created study item 405 entitled “Poker Etiquette”. In another embodiment, the newly-created study item 405 may be placed in a “pending study items” area (504, as shown in FIG. 5) of the user's profile. In either case, the newly-created study item 405 may also be saved into the databases 148₁, 148₂.

Turning now to FIG. 5, an example HTML page 500 illustrating the modification of a learning path 502, in accordance to one embodiment, is shown. As shown, the HTML page 500 may contain a learning path 502 having a plurality of study items 503 and/or a “pending study items” area 504. As previously stated, the “pending study item” 504 area may contain study items 506 created by the user. The “pending study items” area 504 may also store study items 506 which are suggested to the user by other users or algorithms (e.g. via the match and suggest engine 204).

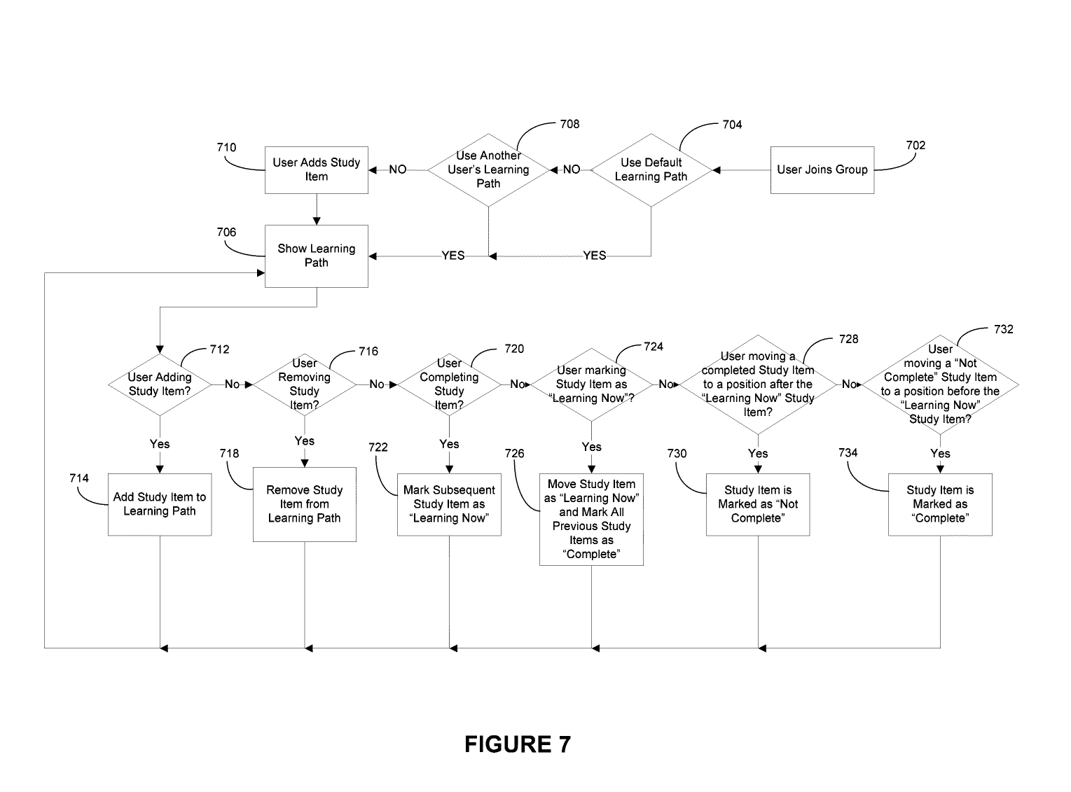

A user may create and/or modify their learning path by adding the study items 506 from the “pending study item” area 504 to their learning path 502. For example, in one embodiment, a user may click-and-drag a study item 506 from the “pending study item” area 504 and place it in their learning path 502. A user may also alter their learning path 502 by rearranging the study items 503 within the learning path 502. For example, in one embodiment, a user may click-and-drag a study item 508 to a new location within the learning path 502. As will be described below, in reference to FIG. 7, the designation of the study item 502 (e.g., “completed,” “learning now,” “not completed”) may change depending on where the study item 502 is moved within the learning path 502. Once a learning path is complete, it may be saved into the databases 148₁, 148₂.

Every user may manage his own learning path(s) 502 within a Group so that one learning path 502 may differ from a learning path 502 of another user. Learning paths 502 may be made or defaulted to a public view so that a user can view other user's learning paths 502 and adopt their study items 503 or even complete learning paths to build upon or improve his own learning paths 502. Study items 503 may also be suggested to and included in a user's learning path 502 by other users, or may also be suggested by an algorithm to find similar study items (via the match and suggest engine 204), which would further improve the user's experience within the Group. In addition, learning paths may be collaboratively managed by a plurality of users. In other words, more than one user may be able to modify the same learning path. In this case, each user may add study items, remove study items, create new study items, and/or rearrange study items within any given learning path.

In one embodiment, the match and suggest engine 204 may suggest study items to be added to a learning path 502 by analyzing a set of criteria including, but not limited to, a user's similarity rating, a discrete rating of a particular study item within the collaborative learning system 146, the number of uses of the study item in different learning paths, and the number of users using the study item in their learning paths and the type of study item.

The match and suggest engine 204 may also analyze a set of discrete metrics that may be assigned to each piece of content, media and information. Such metrics may result in a “weight” or “score” which would put each piece of content, media and information into a certain order. Once a piece of content, media or information reaches a threshold “weight” or “score”, that piece may be promoted to a user's profile page of the website interface of the collaborative learning system 146. The metrics may include (1) the user who submitted a particular piece of content, media or information (e.g., higher rated users who consistently submit good content, media or information may be given extra weight); (2) the number of votes the content, media or information gets by different users within a specified period of time; (3) the number of views the content, media or information gets by different users within a specified period of time; (4) the conversion rate of votes versus views; (5) the relationship of the users who voted on the content, media or information to a particular user; and (6) the status of the content, media or information (e.g., certain content, media or information may be designated as “approved” if it reaches a certain number of votes and may be designated as “unapproved” if it does not reach a certain number of votes).

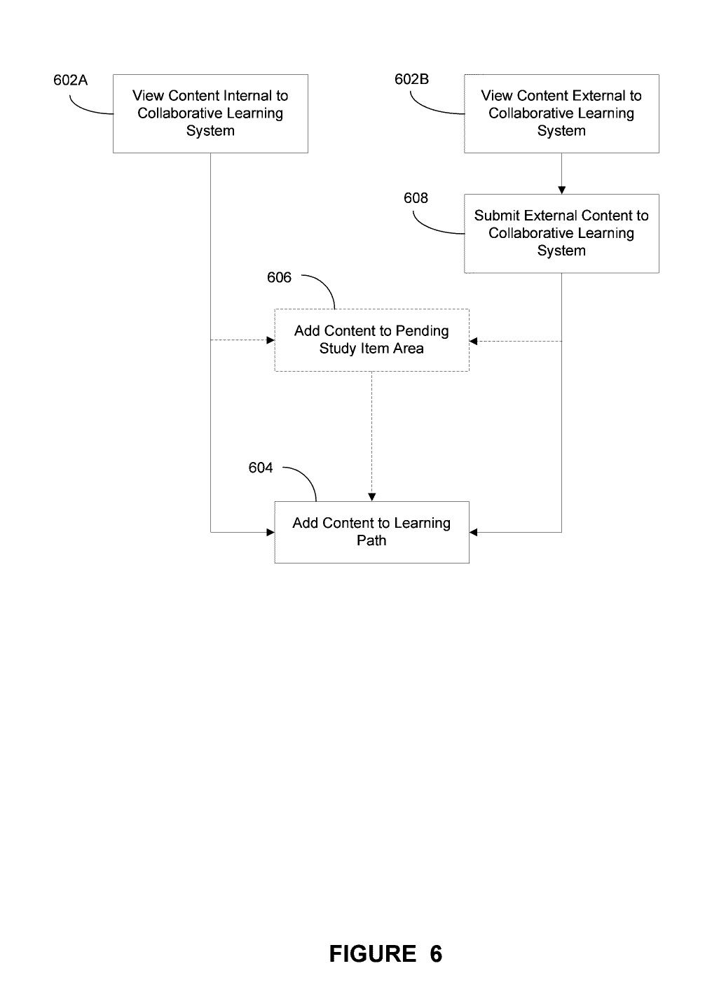

Turning now to FIG. 6, a method for adding study items 503 to a learning path 502, in accordance with one embodiment, is shown. As shown, a study item 503 may be added to the learning path 502 via content viewed internally to the collaborative learning system 146 (e.g. at step 602A), or a study item 502 may be added to a learning path via content viewed externally to the collaborative learning system 146 (e.g., at step 602B). When viewing content internally, at step 602A, the content viewed may be a study item from another user's learning path or a study item that resulted from a search via the search engine 210. The user has an option to add the study item to his learning path 502, and if the user decides to do so, then at step 604, the study item may be added to a learning path 502. In one embodiment, the user may decide to add the study item to the “pending study item” area 504 (at step 606) and may add the study item (at step 604) to the learning path 502 at a later time.

When viewing content externally, at step 602B, the content viewed may be a web page viewed on the Internet that is external the collaborative learning system 146. If the user finds the content relevant, at step 608, the user may submit the external content to the collaborative learning system 146. In one embodiment, the user may submit the external content by creating a study item that links to the external content (as shown in FIG. 4). At step 604, the study item may be added to the learning path 502. In one embodiment, the user may decide to add the study item to the “pending study item” area 504 (at step 606) and may add the study item (at step 604) into the learning path 502 at a later time.

Turning now to FIG. 7, a method for using and rearranging a learning path 502, in accordance with one embodiment, is shown. The method begins at step 702, where a user joins a Group. At step 704, it is determined whether a user wants to use a default learning path (e.g., created by an administrator or Group manager) for the Group. If it is determined that the user decides to use a default learning path, then at step 706, the learning path 502 is shown to the user. On the other hand, if it is determined that the user decides not use a default learning path, it is determined whether the user wants to use another user's learning path at step 708. If it is determined that the user wants to use another user's learning path, then at step 706, the learning path 502 is shown to the user. On the other hand, if it is determined that the user decides not to use another user's learning path, then at step 710, the user begins to build a new learning path by creating and adding the study item to the new learning path. After a user adds the study item, at step 706, the learning path 502 is shown to the user.

At step 712, it is determined if the user is adding another study item to the learning path 502. If it is determined that a user is adding a study item, the study item is added to the learning path at step 714, and the updated learning path 502 is shown at step 706. However, if it is determined that the user is not adding a study item, then at step 716, it is determined if the user is removing a study item. If it is determined that the user is removing a study item, the study item is removed at step 718, and the updated learning path 502 is shown at step 706. However, if the user is not removing a study item, it is determined if the user is “completing” a study item at step 720. If it is determined that the user has completed the study item (e.g., the study item is marked as “complete”), then at step 722, the subsequent study item is marked as “learning now,” and the updated learning path 502 is shown at step 706. However, if it is determined that the user is not “completing” a study item, then at step 724, it is determined if a user is marking a study item as “learning now.” If it is determined that a user is marking a study item as “learning now,” then at step 726, the study item is marked as “learning now,” and all the study items preceding the “learning now” study item are marked as “completed.” The updated learning path 502 is then shown at step 706. However, if it is determined that a user is not marking a study item as “learning now,” then at step 728, it is determined if a user is rearranging the learning path 502 by moving a “completed” study item to a position after a study item marked as “learning now.” If it is determined that the user is rearranging the learning path 502, then at step 730, the study item is designated as “not complete.” The updated learning path 502 is then shown at step 706. However, if it is determined that the user is not rearranging the learning path 502, then at step 732, it is determined if the user is moving a “not complete” study item to a position before the “learning now” study item. If it is determined that the user is rearranging the study item as such, then at step 734, the designation of the study item is changed from “not complete” to “complete.” The updated learning path 502 is shown at step 706. However, if it is determined that the user is not rearranging the learning path 502 as such, then it is determined that no changes are being made to the learning path 502, and the method returns to step 706, where the learning path 502 is displayed.

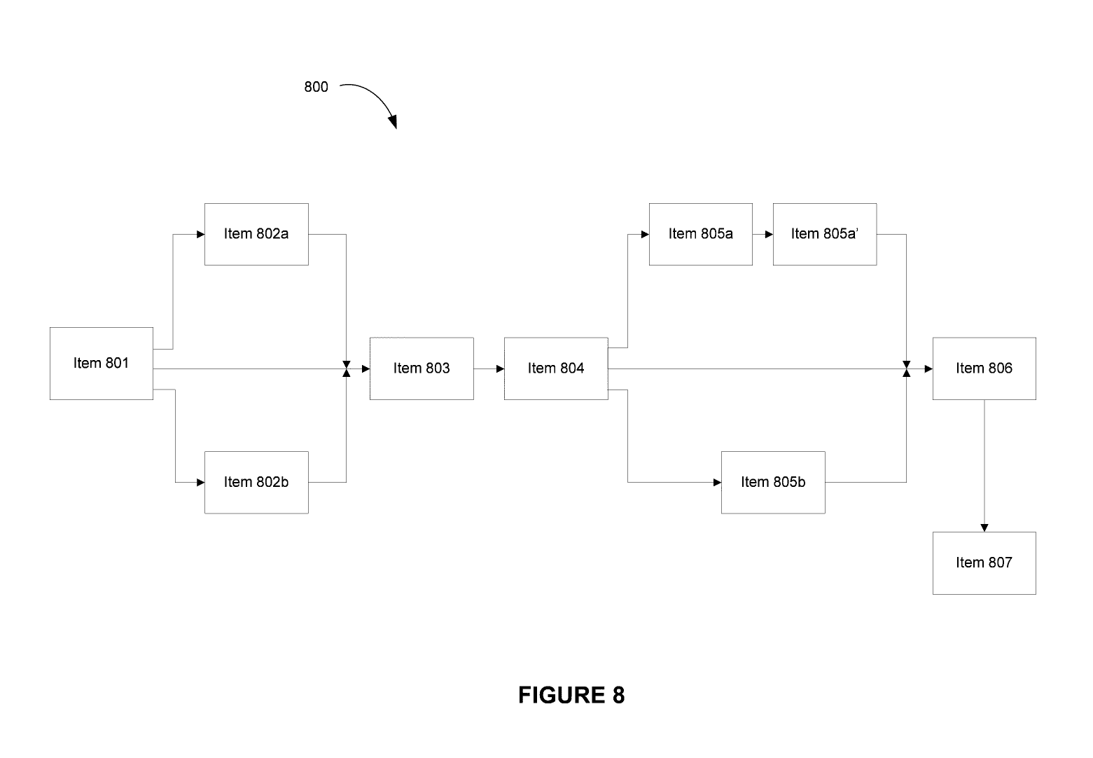

Turning now to FIG. 8, a diagram representing a snapshot of a collaborative learning path 800 with study items 801, 802a, 802b, 803, 804, 805a, 805a′, 805b, 806, 807 to which more than one user has contributed, in accordance with one embodiment, is shown. Here, the learning path 800 begins with study items 801, 803, 804, 806 and 807. For his particular learning path 800, User A then adds study items 802a, 805a and 805a′. User B then replaces study item 802a with study item 802b and study items 805a and 805a′ with 805b. Another user, User C, may encounter this particular learning path 800 and, within the collaborative learning system 146, be given a choice (e.g., via a “decision” study item) after study item 801 of choosing the path to study item 802a, the path to study item 802b or the path to study item 803. After study item 804, User C is given a choice between the path to study item 805a and 805a′, the path to study item 805b or the path to study item 806. In this example, there are therefore nine different permutations of the same learning path 800: (801, 802a, 804, 805a, 805a′, 806, 807); (801, 802a, 803, 804, 806, 807); (801, 802a, 803, 804, 805b, 806, 807); (801, 803, 804, 805a, 805a′, 806, 807); (801, 803, 804, 806, 807); (801, 803, 804, 805b, 806, 807); (801, 802b, 803, 804, 805a, 805a′, 806, 807); (801, 802b, 803, 804, 806, 807); and (801, 802b, 803, 804, 805b, 806, 807). Any user may change the order or number of study items in a particular learning path to create a tailored learning path for a particular subject matter.

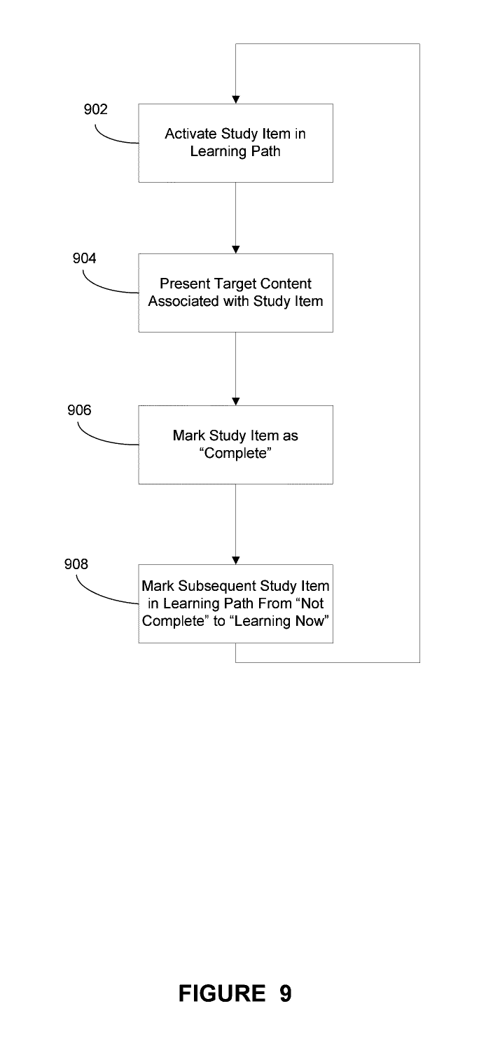

Turning now to FIG. 9, a method for traversing a learning path 502, in accordance to an embodiment of the present invention, is shown. The method begin at step 902, where a user activates a study item 503 in the learning path 502 (e.g., by clicking on a hyperlink embedded within the study item 503). Upon activating the study item 503, at step 904, the user is presented with the target content associated with the study item 503. For example, in one embodiment, the user may be presented with a new browser window (or browser tab) containing the target content (e.g. a web page) associated with that study item 503. As previously stated, the study item may also be a “decision” study item, which may provide a user an option to select between one of several study items as the next study item in the learning path. At step 906, once the user is finished studying the target content, the user closes the browser window (or tab) and marks the study item 503 in the learning path 502 as “completed.” At step 908, the status of the next study item in the learning path 502 is changed from “not complete” to “learning now”, and the method return to 902, where the user activates the next study item 503 in the learning path 502.

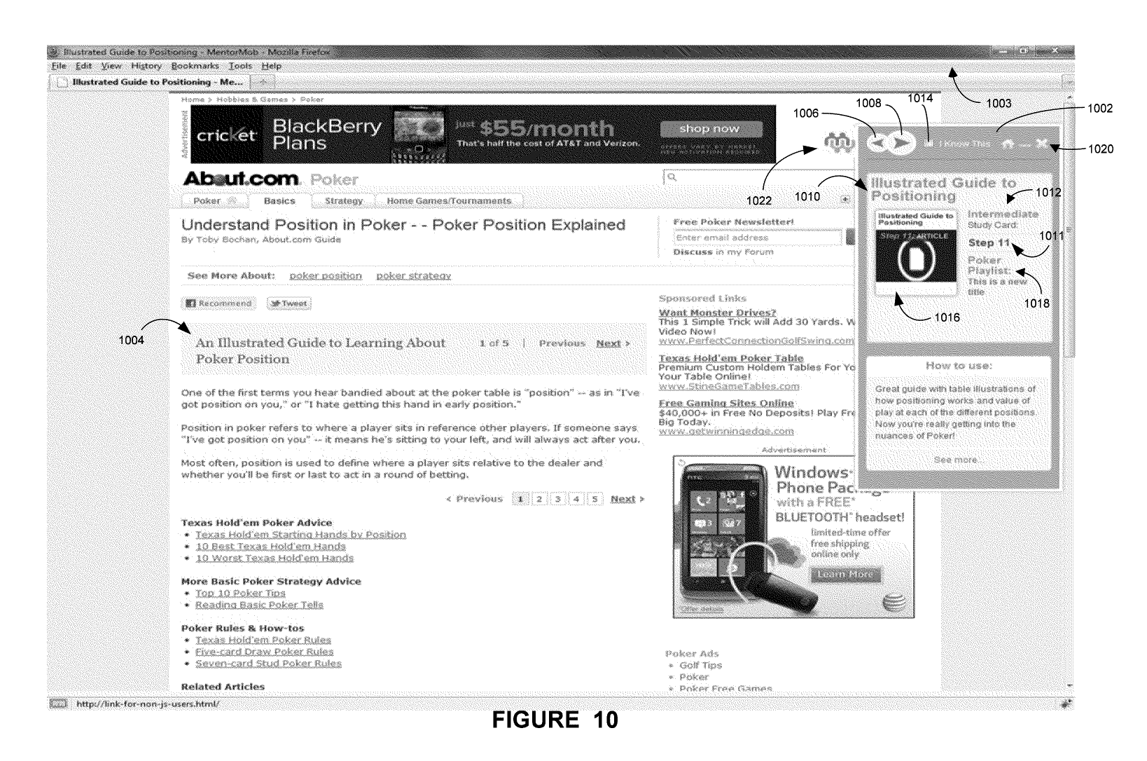

In another embodiment, a user may traverse a learning path 502 via a navigational pane that may be embedded over the target content (e.g., using an iFrame overlay). Turning now to FIG. 10, an example HTTP page including a navigational pane 1002 embedded over target content 1004, in accordance with one embodiment, is shown. In this embodiment, once a user activates a study item 503, the user may be presented with a new browser window (or tab) 1003 that not only contains the target content 1004, but also the navigation pane 1002 displayed over the target content 1004. The navigation pane 1002 allows a user to traverse a learning path 502 without having to return to the original browser window containing the learning path 502.

The navigation pane 1004 includes navigation buttons 1006, 1008, which allow a user to go forward or backward in the learning path 502. The navigation pane 1002 may also include the following information: (1) title of the study item 1010; (2) a description of the study item (not shown); (3) the position 1011 the current target content 1004 is within the learning path 502; (4) the skill level 1012 of the target content with respect to the learning path 502 (e.g., beginner, intermediate, advanced); (5) a button 1014 to mark the target content as “completed” learning; (6) a graphical representation 1016 of the study item; statistics on how many times the card has been viewed, completed, date it was submitted, who submitted it, etc (now shown); (7) the title of the learning path which contains this study item 1018; a button 1020 to close the navigation pane 1002 completely and send the user directly to the target content; and an advertisement (not shown) relating to the content shown in the browser window 1003. In one embodiment, the advertisements may be targeted to a user in accordance to the user's skill level, as determined by the learning path. In a further embodiment, the navigation pane 1002 may have forking option (e.g., via a study item or another button on the navigation pane 1002), which may provide a user an option to select between one of several study items as the next study item in the learning path 302. The forking option may also provide a user an option to switch to another learning path. That is, one learning path may be linked to another learning path.

Once the user has studied the content, the user may mark the study item as “learned” directly in the navigation pane 1002 (via button 1014) as opposed to marking the study item as “learned” directly in the learning path 502). Thereafter, a user may view the content associated with the next study item 503 in the learning path 502 by using the directional arrow buttons 1006, 1008. For example, by activating the “next” button 1008, the browser window 1003 will be updated with the target content associated with the next study item in the learning path 502. Alternatively, by clicking on the “previous” button 1006, the browser window 1003 will be updated with the target content associated with the previous study item in the learning path 502. In either case, the navigation pane 1002 is updated to reflect the study item that is currently being viewed (e.g., via the graphical representation 1016).

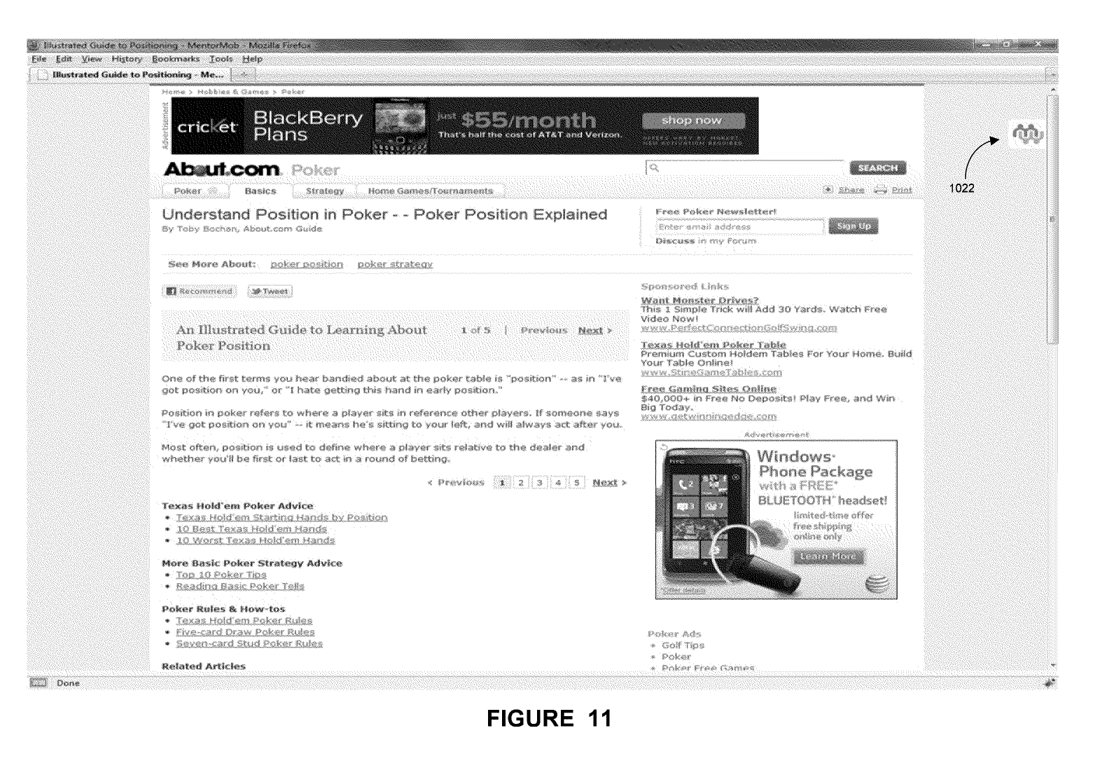

In one embodiment, the navigation pane 1002 may be collapsible to enable a greater viewing area of the target content 1004 displayed in the browser window 1003. In one embodiment, the navigation pane 1002 may be collapsed by activating a “collapse/expand” button 1022. Turning briefly to FIG. 11, a navigation pane 1002 in its collapsed form, in accordance to an embodiment of the present invention, is shown. As shown, the collapsed navigation pane 1002 is represented by the “collapse/expand” button 1022. To expand the navigation pane 1002, the user may activate the “collapse/expand” button 1022, and the navigation pane 1002 will expand into its expanded form (as shown in FIG. 10).

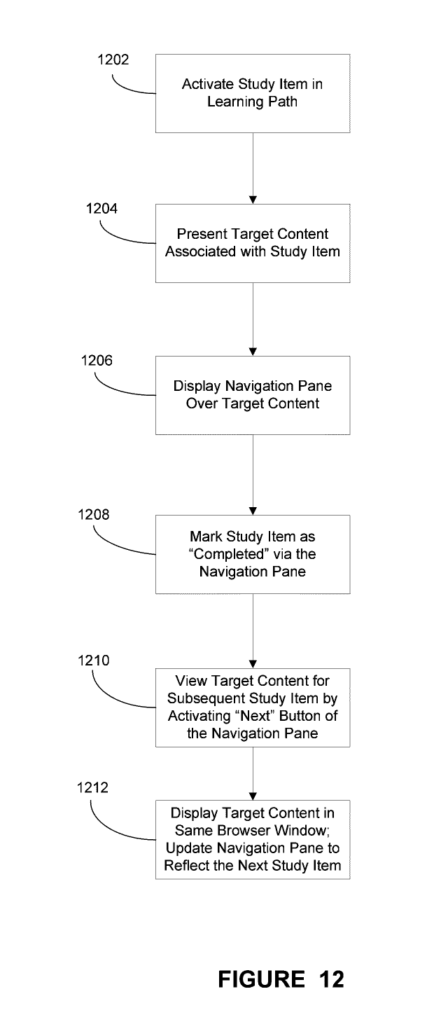

Turning now to FIG. 12, a method for traversing a learning path using a navigation pane 1002, in accordance to an embodiment of the present invention, is shown. The method begins at step 1202, where a user activates a study item 503 in the learning path 502 (e.g., by clicking on a hyperlink embedded within the study item 503). Upon activating the study item 503, at step 1204, the user is presented with the target content associated with the study item 503. For example, in one embodiment, the user may be presented with a new browser window (or browser tab) containing the target content (e.g. a web page) associated with that study item 503. At step 1206, a navigation pane 1002 is displayed over the target content. At step 1208, after studying the target content, the user may mark the study item 503 as “completed” within the navigation pane 1002. In doing so, the corresponding study item 503 in the learning path 502 is also marked as “completed.” At step 1210 the user may activates the “next” button 1008 to view the target content of the next study item. At step 1212, the target content is loaded in the same browser window, and the navigation pane 1002 is updated to reflect the next study item. The user may repeat the above-mentioned steps until the learning path 502 is fully traversed. The user may traverse the learning path 502 in either direction (forwards or backwards) by using the navigation buttons 1006, 1008. This embodiment provides the user a convenient method for traversing a learning playlist and viewing target content within the same browsing window/tab.

In one embodiment, the collaborative learning system 146 may allow users to receive a reputation or reputation score. This score may be based on a variety of criteria such as, but not limited to, reviews from previous teaching relationships, the number of users who have been mentored/taught by this particular user, the number of friends/connections of this particular user within the community of the collaborative learning system 146, the number of learning paths created by this user, the number of submitted study items by this user, the degree to which one or more learning paths have been modified, and/or the degree to which one or more learning paths have been optimized (i.e., the adding, removing, and/or re-ordering of study items within one or more learning paths).

In one embodiment, a number of learning paths within the collaborative learning system 146 may be managed by visually representing and plotting all learning paths on a single plane. For example, a user can then zoom in to view specific details of a learning path A (but no details of other learning paths), zoom out to see more learning paths (and more general details of these learning paths), then zoom in again to view specific details of a learning path B. This method can be analogized to the process of a hot-air balloon starting from a low altitude and persons within the bucket observing many details of a small piece of land A below, the hot-air balloon gaining altitude and persons observing less detail of the small piece of land A below but an increasingly larger area of land, the hot-air balloon moving parallel to the land and stopping to hover over another small piece of land B, then the hot-air balloon decreasing altitude to finally see many details of the small piece of land B below.

In one embodiment, the collaborative learning system 146 may allow advertisers to target their ads to users with a granularity finer than what is available in the current art. Specifically, the collaborative learning system 146 may allow advertisers to specifically target ads to users with very fine detail due to the amount of information that may be known to the advertisers. For example, an advertiser may be able to determine a user's age, gender, location, interests, combination of interests (e.g., an advertiser may deduce that a user learning snowboarding, mountain biking, and rock climbing may also like other adventure or extreme sports), experience level within each interest, friends, how quickly the user is learning, what percentage of time is spent on which interests, and/or other criteria. As a result, the conversion rates may be increased. That is, the rate at which someone viewing and ad and actually taken action (e.g., clicking the ad or actually making a purchase) on the advertisement may be increased. As previously stated, the ads may be targeted based on the skill level of the user. For example, consider a user learning to play a guitar. Further consider that the user is determined to be at an intermediate skill level. In this case, the user may be shown intermediate-level advertisements (e.g., products, accessories, and services as they pertain to an intermediate guitar player) rather than beginner-level advertisements.

The collaborative learning system 146 may allow advertisers to target ads to users by the following method. First, the collaborative learning system 146 may transmit detailed information regarding a user to the advertiser. For example, the collaborative learning system 146 may transmit a user's age, gender, location, interests, combination of interests, experience level within each interest, friends, how quickly the user is learning, what percentage of time is spent on which interests, and/or other criteria. Next, the collaborative learning system 146 may receive an advertisement generated by the advertiser using the information transmitted to the advertiser. Finally, the collaborative learning system 146 may display the targeted advertisement to the user.

It is noted that embodiments of the present invention may facilitate learning by passing on knowledge from one user to another using the mentor(teacher)/mentee(student) model, visual learning paths, and/or a framework of Groups within a website. The information sharing is not necessarily limited to amateur/non-professional Groups, but can also include traditional education, professional organizations, third-party organizations, and/or any other organizations where any person can utilize the collaborative learning system 146 and methods to further his learning. In addition, a learning path may be used as a marketing and revenue tool to promote various branded products and/or services as study items.

It is noted that the example HTML pages are merely exemplary implementations, and a person of skill in the art having the benefit of this disclosure would recognize that the appearance of these page may be modified in any number of ways without affecting its functionality and suitability for these embodiments. The web pages also display a number of options that are entirely separate from or complementary to the system described herein, which are entirely optional.

It is contemplated that the parts and features of any one of the specific embodiments described can be interchanged with the parts and features of any other of the embodiments without departing from the spirit and scope of the present disclosure. The foregoing description discloses and describes merely exemplary embodiments of the present disclosure and is not intended to be exhaustive or to limit the disclosure to the precise form disclosed. As will be understood by those skilled in the art, the disclosure may be embodied in other specific forms, or modified or varied in light of the above teachings, without departing from the spirit, novelty or essential characteristics of the present disclosure. Accordingly, the disclosed embodiments are intended to be illustrative, but not limiting, of the scope of the invention, which is set forth in the following claims. The exclusive right to all modifications within the scope of this disclosure is reserved.

What is claimed:

1. A computer-implemented method, comprising:
creating one or more study items;
storing electronically the one or more study items;
adding the one or more study items to a learning path, wherein the learning path is electronically stored, and wherein each of the one or more study items has an associated designation; and
arranging the one or more study items within the learning path in a logical order, wherein the learning path incrementally provides information regarding a particular topic as the learning path is traversed.

2. The computer-implemented method of claim 1, further comprising:
receiving a suggestion of one or more study items to be added to the learning path; and
adding at least one of the suggested one or more study items to the learning path.

3. The computer-implemented method of claim 1, wherein the learning path is shareable and editable among a plurality of electronic devices.

4. The computer-implemented method of claim 1, further comprising:
determining that a study item if of a first designation; and
assigning a skill level in response to determining that the study item is of the first designation.

5. The computer-implemented method of claim 1, wherein creating one or more study items comprises:
assigning target content to the one or more study items; and
providing access to the target contact via the one or or more study items.

6. The computer-implemented method of claim 1, further comprising:
rearranging the one or more study items within the learning path, wherein the designation of one or more study items is automatically changed from a first designation to a second designation if the one or more study items are placed before a study item having a third designation.

7. The computer-implemented method of claim 1, further comprising:
rearranging the one or more study items within the learning path, wherein the designation of one or more study items is automatically changed from a first designation to a second designation if the one or more study items are placed after a study item having a third designation.

8. A system, comprising:
a processor; and
a memory containing a program, which when executed by the processor, is configured to perform an operation, the operation comprising:
creating one or more study items;
storing electronically the one or more study items;
adding the one or more study items to a learning path, wherein the learning path is electronically stored, and wherein each of the one or more study items has an associated designation; and
arranging the one or more study items within the learning path in a logical order, wherein the learning path incrementally provides information regarding a particular topic as the learning path is traversed.

9. The system of claim 8, further comprising:
receiving a suggestion of one or more study items to be added to the learning path; and
adding at least one of the suggested one or more study items to the learning path.

10. The system of claim 8, wherein the learning path is shareable and editable among a plurality of electronic devices.

11. The system of claim 8, further comprising:
determining that a study item if of a first designation; and
assigning a skill level in response to determining that the study item is of the first designation.

12. The system of claim 8, wherein creating one or more study items comprises:
assigning target content to the one or more study items; and
providing access to the target contact via the one or more study items.

13. The system of claim 8, further comprising:
rearranging the one or more study items within the learning path, wherein the designation of one or more study items is automatically changed from a first designation to a second designation if the one or more study items are placed before a study item having a third designation.

14. The system of claim 8, further comprising:
rearranging the one or more study items within the learning path, wherein the designation of one or more study items is automatically changed from a first designation to a second designation if the one or more study items are placed after a study item having a third designation.

15. A computer-readable storage medium containing a program, which when executed by the computer performs an operation, the operation comprising:
creating one or more study items;
storing electronically the one or more study items;
adding the one or more study items to a learning path, wherein the learning path is electronically stored, and wherein each of the one or more study items has an associated designation; and
arranging the one or more study items within the learning path in a logical order, wherein the learning path incrementally provides information regarding a particular topic as the learning path is traversed.

16. The computer-readable storage medium of claim 15, further comprising:
receiving a suggestion of one or more study items to be added to the learning path; and
adding at least one of the suggested one or more study items to the learning path.

17. The computer-readable storage medium of claim 15, wherein the learning path is shareable and editable among a plurality of electronic devices.

18. The computer-readable storage medium of claim 15, further comprising:
determining that a study item if of a first designation; and
assigning a skill level in response to determining that the study item is of the first designation.

19. The computer-readable storage medium of claim 15, wherein creating one or more study items comprises:
assigning target content to the one or more study items; and
providing access to the target contact via the one or or more study items.

20. The computer-readable storage medium of claim 15, further comprising:
rearranging the one or more study items within the learning path, wherein the designation of one or more study items is automatically changed from a first designation to a second designation if the one or more study items are placed before a study item having a third designation.
